(19) United States
(12) Patent Application Publication
(10) Pub. No.: US 2011/0113102 A1
(43) Pub. Date: May 12, 2011

(54) METHOD AND APPARATUS FOR INTEGRATING A PARTICIPANT INTO PROGRAMMING

(75) Inventor: Erik Jacob Johnson, Dublin, CA (US)

(73) Assignee: CBS Interactive Inc., San Francisco, CA (US)

(21) Appl. No.: 12/942,226

(22) Filed: Nov. 9, 2010

Related U.S. Application Data
(60) Provisional application No. 61/259,416, filed on Nov. 9, 2009.

(51) Int. Cl. H04N 9/80; G06F 15/16

(52) U.S. Cl. 709/205; 386/262; 386/E09.011

(57) ABSTRACT

A method and apparatus for integrating a participant into video programming. A list of available social network data fields is received. Programming segments to be customized based on the available social network data fields are detected. At least one of the available social network data fields is correlated with the programming segment to be customized. Personal data of a specific user corresponding to the at least one of the available social network data fields is retrieved and the programming segment is modified to include information based on the personal data.

### RELATED APPLICATION DATA

This application claims benefit of U.S. Provisional Application Ser. No. 61/259,416 filed on Nov. 9, 2009, the entire disclosure of which is incorporated herein by reference.

### BACKGROUND

1. Field of the Invention

The invention relates to integrating a participant into programming, such as video programming.

2. Related Art

Traditionally, programming, such as television and other video programming, is recorded and then broadcast or otherwise distributed to viewers. The programming is predetermined to appeal to the audience and is not modified for specific viewers. Of course, it is known to broadcast, or otherwise distribute, live programming in real time. However, such live programming still is not ordinarily modified to suit specific users.

United States Patent Application 2001/0013123 discloses a method for customizing programming to individual users based upon the user's profile or responses to contemporaneous queries. A programming transmission center maintains multiple MPEG storage server environments. Through the use of digital conversion and MPEG compression standards, a vast library of programming and other information signals can be stored on the file servers. The transmission center selects and accesses programming segments or other information from the storage servers. Using splice points encoded through the MPEG process, the programming transmission center splices disparate program segments together to create a single custom program stream for delivery to a single user or multiple users of the same profile. The system described in United States Patent Application 2001/0013123 is complex and requires a vast library of content to be stored for splicing into a single program. Also, this system is directed to creating content that is of interest to the user but does not integrate the user into the programming.

More recently, social networks and other communities have become popular. In such communities, people share personal information, such as their location of residence, interests, occupation, and relationships with others over a computer network. Such communities bring people of like interests and backgrounds together by facilitation matching and communication. Social networks have been used to bring together groups of people having an interest in specific programming, such as popular television shows. For example, many television shows have a page on Facebook™ through which users can communicate, enter contests, get additional content, and the like.

Book publishers have used forms filled out by a customer to put personal information into a book. As an example, a form can be filled out with a child's name and city of residence. A book of a children's story can then be printed and the main character of the story can have the child's name and the character can live in the child's city of residence. This type of printed media is static and must be prepared individually for each person. Further, the story and the type of personal information in the form must be prepared in coordination with each other.

### BRIEF DESCRIPTION OF THE DRAWING

The accompanying drawings, which are incorporated in and constitute a part of this specification and, together with the description, describe embodiments. The drawings are not intended to depict every feature of actual embodiments nor relative dimensions of the depicted elements, and are not drawn to scale.

FIG. 1 is a schematic block diagram of an embodiment of a computer architecture:

FIG. 2 is a schematic functional diagram of an embodiment for integrating a participant into programming:

FIG. 3 is a high level flow chart of an embodiment of a method for integrating a participant into programming:

FIG. 4a is a schematic illustration of an example of a social network data structure that can be used to select segments for modification and to modify the content:

FIG. 4b is a schematic illustration of an example of tagged video programming data:

FIG. 5 is a detailed flow chart of an embodiment of a method for integrating a participant into programming: and

FIG. 6 is a mock-up example of a screen shot of programming content modified to include participant information.

### DETAILED DESCRIPTION

Embodiments disclose systems and methods for integrating a participant into programming, such as television programming. In some embodiments, systems and methods use data from a social network. Of course, embodiments may also use other data or integrate a user into other types of content.

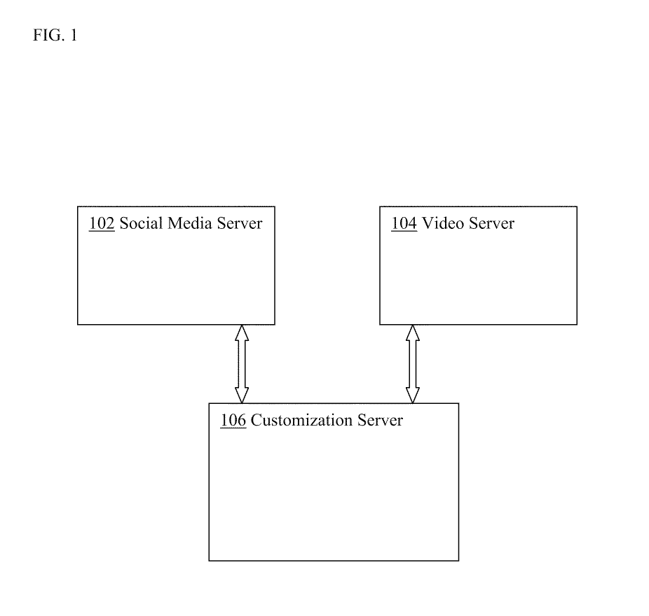

FIG. 1 illustrates a computer architecture of an embodiment. Social media server 102 can be any device storing social media data, such as a social network server. Video server 104 can be any device storing or processing programming data, such as video programming data. Customization server 106 is one or more computing devices that effect the processes of the embodiments described below. The servers can be general purpose server computers programmed in an appropriate manner with software executing thereon to define modules for effecting the desired functions.

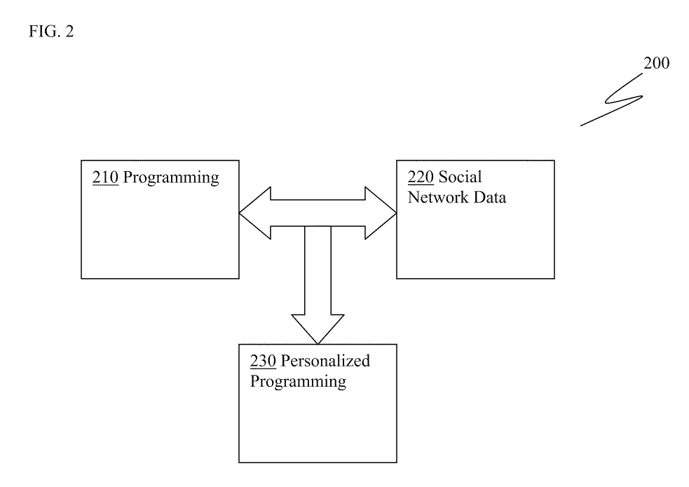

FIG. 2 is a schematic block diagram of an overview of a process 200 for integrating a user into programming. Programming 210, such as a television program is analyzed with respect to personal data, such as social network data 220. The programming is then modified to integrate the identity of a user into the programming. The term “identity” as used herein, is to be construed broadly to include any information about, or relating to, the user, such as the user's likeness, preferences, hobbies, location of work or residence, or the like. The resulting programming thus simulates that the user is part of the programming.

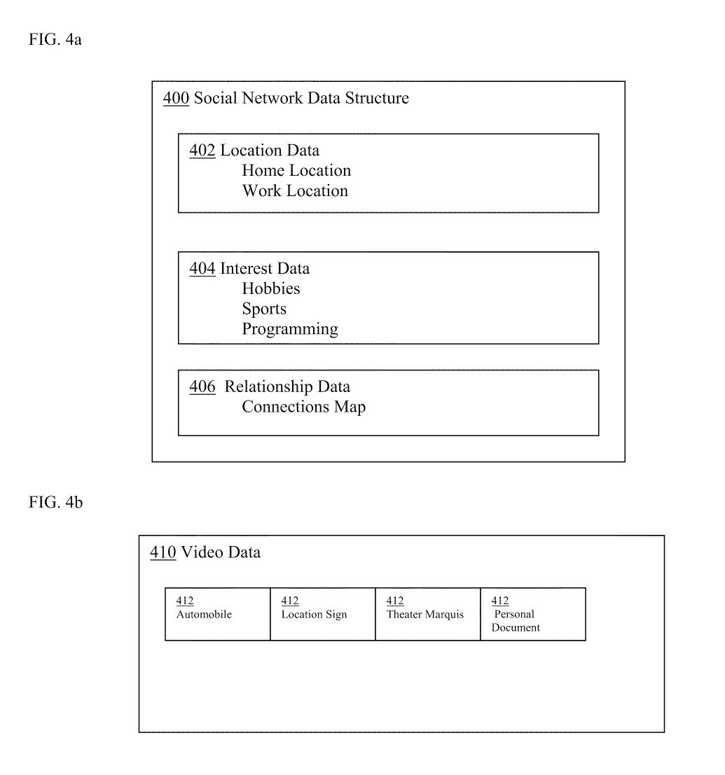

On example of personal data, that can be used is social network data 220. FIG. 4a illustrates a simplified example of a data structure of a social network record. Social networks, such as FACEBOOK™ are well known. FACEBOOK™ provides a Graph API which allows developers to read the FACEBOOK™ social graphs. Other APIs provide the ability to read user data, with proper authentication. Such APIs can be used to collect the user data. However, user data can be obtained in any manner, such as through user profiles, bots, crawlers, or the like.

In FIG. 4a, social network data 400 includes three data classifications, Location data 402, Interest data 404, and relationship data 406. Examples of location data 401 include home location and work location. Other location data could be favorite cities or countries, locations visited, locations of previous residences, schools, jobs, or the like. Examples of interest data 404 include hobbies, favorite sports, or favorite programming of the user. However, interest data can include any data indicating interests of the user, such as favorite musical performers, favorite names, and the like. Relationship data 406 can include the social connection map of a user indicating the users relationships with other people, such as FRIEND, FRIEND OF A FRIEND, and the like. However, relationship data can be any data indicating one or more relationships between the user and other people. In the disclosed embodiment, each classification of data has one or more types of data stored as data fields containing values in one or more data structures, along with any appropriate metadata, in a known manner. Social network data 220 can be stored in social media server 102.

FIG. 4b illustrates a simplified example of programming data, as video data 410 stored as multiple segments 412. The segments are tagged to facilitate associating the segments with user data as described below. For example the illustrated segments 412 are tagged, as illustrated, by subject matter contained in the segments.

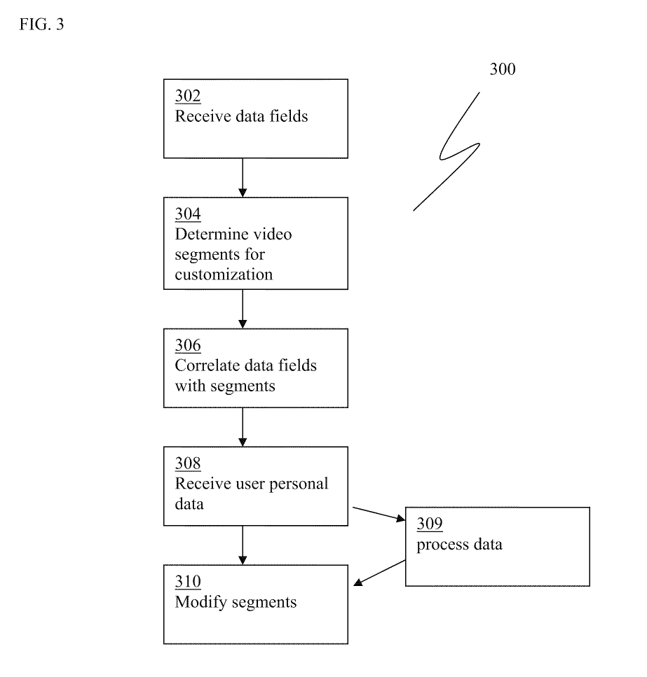

FIG. 3 illustrates a method, in accordance with an embodiment, for personalizing programming, such as a television show. Available data fields of personal information are received in step 302. For example, available FACEBOOK™ APIs can be used to ascertain the available data fields. For example, available fields can be HOME ADDRESS, NAME, FAVORITE SONG, FRIENDS, and the like. In step 304, the programming, video programming in the embodiment, is scanned and parsed to determine potential segments for customization. As a simple example, a segment with a vehicle and a segment with a theater marquis could be selected for modification as noted below. More specifically, since HOME ADDRESS was determined as an available data field, the license plate of the vehicle could be customized to correspond to the state of a HOME ADDRESS. Similarly, the marquis could be customized to feature the band that performs a FAVORITE SONG. In step 306, the data fields received in step 302 are mapped, e.g., correlated to, the segments selected in step 304.

In step 308, the data of the specific user is accessed and the values corresponding to the data fields determined in step 306 are read. As an example, the value for FAVORITE SONG could be “Stairway to Heaven”. In step 309, the value is processed if necessary. In this example, the value “Stairway to Heaven” can be used to query a song database to determine that the song is performed by the band Led Zeppelin. Of course, step 309 is optional and might not be necessary of the value corresponds directly to programming segment. In step 310, the programming segments determined in step 304 are customized with the value, or the processed result of the value. As an example, the name on the marquis in a segment can be customized to read “Led Zeppelin”.

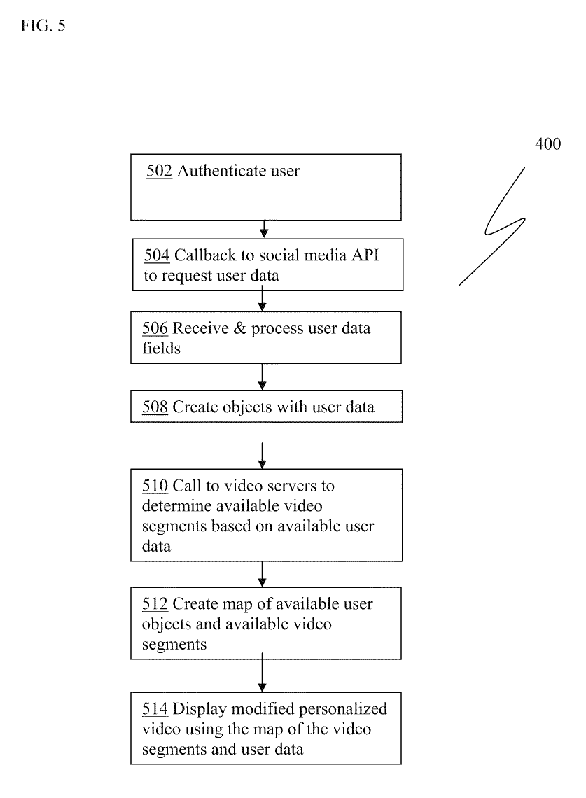

FIG. 5 illustrates a method of an embodiment with more detail of the communications technology and data flow. In step 502, a user of a social network or other social media (or an agent of the user) is authorized, using OAuth 2.0 for example. OAuth is a standard protocol for permitting publication of, and interaction interact with, protected data. This protocol allows data repositories and users to provide secure access to data without the need for distributing the user password. If the authentication is positive, in step 504, a call to the social media can be made through the API of the social media, using JavaScript for example. In step 506, the user data fields that are available are processed and received.

In step 508, the user data can be packaged as objects. As an example, the object can comply with the AS3 (Applicability Statement 3) or the PHP (Hypertext Preprocesor) standards. AS3 is a standard by which applications communicate EDI (or other data such as XML) over the Internet using FTP (File Transfer Protocol). PHP is a general-purpose scripting language that can be embedded into an HTML document and interpreted by a web server.

In step 510, a call is made to the video server(s) to determine available video segments corresponding to the available user data. The video segments can be pre coded with the type of user data that corresponds to the particular segments. For example, the segments can be tagged by topic, contained graphics (as illustrated in FIG. 4b), or other attributes that facilitate matching user data to the segments. If specific user data is not available, certain video segments possibly cannot be used. In step 412, a mapping is created between available user objects and available video segments. In step 414, the user data is inserted into the video segments and displayed based on the mapping.

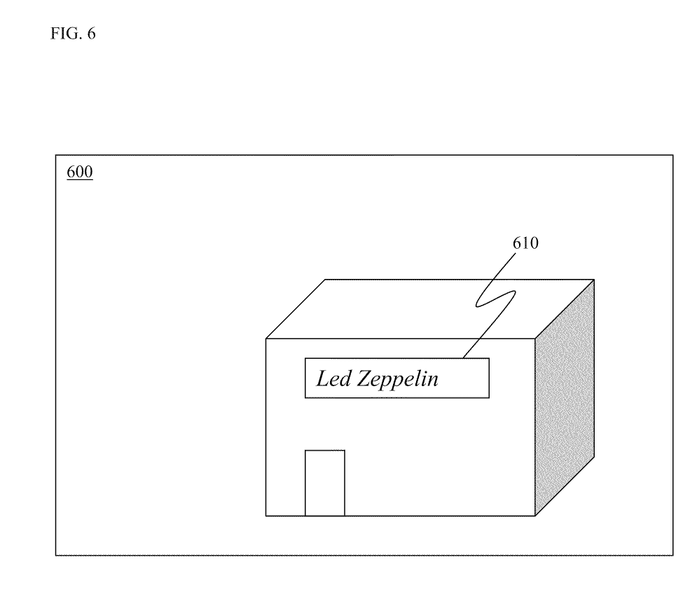

FIG. 6 illustrates a screen shot of a frame of video programming. Frame 600 includes marquis 610 that has been modified by inserting user identity data therein.

It should be noted that the system is illustrated and discussed herein as having various modules which perform particular functions and interact with one another. It should be understood that these modules are merely segregated based on their function for the sake of description and represent computer hardware and/or executable instructions (e.g., software code) which may be stored on a computer-readable medium for execution on appropriate computing hardware. The various functions of the different modules and units can be combined or segregated as hardware and/or software stored on a computer-readable medium as modules in any manner, and can be used separately or in combination.

It should be understood that processes and techniques described herein are not inherently related to any particular apparatus and may be implemented by any suitable combination of components. Further, various types of general purpose devices may be used in accordance with the teachings described herein. It may also prove advantageous to construct a specialized apparatus to perform the method steps described herein. Embodiments have been described in relation to particular examples, which are intended in all respects to be illustrative rather than restrictive. Of course, many different combinations of hardware, software, and firmware will be suitable for practicing the embodiments. The computer devices can be PCs, handsets, set top boxes, servers, PDAs or any other device or combination of devices which can carry out the disclosed functions in response to computer readable instructions recorded on media. The phrase “computer system”, as used herein, therefore refers to any such device or combination of such devices.

Other implementations will be apparent to those skilled in the art from consideration of the disclosure herein. Various aspects and/or components of the described embodiments may be used singly or in any combination. It is intended that the specification and examples be considered as exemplary only, with a true scope and spirit of the invention being indicated by the following claims.

What is claimed:

1. A computer-implemented method for integrating a participant into video programming comprising:
receiving, by a computing device, a list of available social network data fields;
detecting a video programming segment to be customized based on the available social network data fields;
correlating at least one of the available social network data fields with the video segment to be customized;
receiving, by a computing device, personal data of a specific user corresponding to the at least one of the available social network data fields; and
modifying the video programming segment to include information based on the personal data.

2. The method of claim 1, wherein the at least one of the social network data fields is selected from the list of location, occupation, friends, and interests.

3. The method of claim 1, wherein said detecting step comprises parsing the content of video programming and determining a segment of the video programming that contains content related to at least one of the available social network data fields.

4. The method of claim 3, wherein said determining step comprises reading at least one tag associated with a video segment, said tag being indicative of the content contained in the video segment.

5. The method of claim 1, further comprising processing the personal data received in the step of receiving personal data and wherein said information in said modifying step is the result of the processing step.

6. A system for integrating a participant into video programming comprising:
a receiving module configured to receive a list of available social network data fields;
a detecting module configured to detect a video programming segment to be customized based on the available social network data fields;
a correlating module configured to correlate at least one of the available social network data fields with the video segment to be customized;
a personal data receiving module configured to receive personal data of a specific user corresponding to the at least one of the available social network data fields; and
a modifying module configured to modify the video programming segment to include information based on the personal data.

7. The system of claim 6, wherein the at least one of the social network data fields is selected from the list of location, occupation, friends, and interests.

8. The system of claim 6, wherein said detecting module step comprises a parsing module configured to parse the content of video programming and determine a segment of the video programming that contains content related to at least one of the available social network data fields.

9. The system of claim 8, wherein said parsing module is configured to read at least one tag associated with a video segment, said tag being indicative of the content contained in the video segment.

10. The system of claim 10, further comprising a processing module configured to process the personal data received in the step of receiving personal data and wherein said information in said modifying step is the result of the processing step.

11. Computer readable media having instructions recorded thereon for causing a processor to carry out a method for integrating a participant into programming when the instructions are executed, the method comprising:
receiving a list of available social network data fields;
detecting a video programming segment to be customized based on the available social network data fields;
correlating at least one of the available social network data fields with the video segment to be customized;
receiving personal data of a specific user corresponding to the at least one of the available social network data fields; and
modifying the video programming segment to include information based on the personal data.

12. The media of claim 11, wherein the at least one of the social network data fields is selected from the list of location, occupation, friends, and interests.

13. The media of claim 11, wherein said detecting step comprises parsing the content of video programming and determining a segment of the video programming that contains content related to at least one of the available social network data fields.

14. The media of claim 13, wherein said determining step comprises reading at least one tag associated with a video segment, said tag being indicative of the content contained in the video segment.

15. The media of claim 11, further comprising processing the personal data received in the step of receiving personal data and wherein said information in said modifying step is the result of the processing step.
